(19) United States
(12) Patent Application Publication
(10) Pub. No.: US 2010/0063962 A1
(43) Pub. Date: Mar. 11, 2010

(54) Interactive System that, Inter Alia, Does Away with the Need for a User, to Create, Store, Organize and/or Share Files and/or Uniform Resource Locators in Folders and Sub Folders, on a Computer System, Mobile Device, or on a Networks, Blogs, Forums, Intranets, Wireless Application Protocol Portals and the Like

(76) Inventor: Gautam Dharamdas Goradia, Mumbai (IN)

Correspondence Address: INTELLECTUAL PROPERTY LAW GROUP LLP, 12 SOUTH FIRST STREET, SUITE 1205, SAN JOSE, CA, 95113, US

(21) Appl. No.: 12/516,350

(22) PCT Filed: Nov. 23, 2007
(86) PCT No.: PCT/IN2007/000555

§ 371 Date: May 26, 2009

(30) Foreign Application Priority Data
Nov. 27, 2006 (IN) 1948/MUM/2006
Apr. 2, 2007 (IN) 659/MUM/2007

(51) Int. Cl. G06F 17/30

(52) U.S. Cl. 707/640; 707/738; 707/E17.046; 707/E17.005

(57) ABSTRACT

An interactive system that, inter alia, does away with the need for a user, to create, store, organize and/or share files and/or uniform resource locators in folders and sub folders, on a computer system, mobile device, or on a communications site comprising of one or more websites, networks, blogs, forums, intranets, wireless application protocol portals and the like. The said system allows the user to organize files and/or uniform resource locators by linking the same to records in a databank classified by well-defined classifications, and further allows the user to perform various actions on the records in the databank including but not limited to modifying records, cloning records, cross-referencing records, finding records by none or one or more find conditions, bookmarking records as well as marking records as ‘public’ or ‘private’ as well as ‘favorite’, encrypting and decrypting records for the purpose of security, and setting records as ‘templates’ to create new records.

### FIELD OF THE INVENTION

The present invention primarily relates to the field of electronic file management systems present on a computer system, mobile device, or on a communications site comprising of one or more websites, networks, blogs/forums, intranets, WAP (Wireless Application Protocol) portals, and the like.

### BACKGROUND OF THE INVENTION

It is a well accepted fact that in today's times computer systems and related technologies have permeated every sphere of life. Almost every person has access to a computer system either at home or at work. People perform a multitude of tasks using a computer system like storing electronic documents and other data, maintaining account ledgers, communicating via mediums like e-mail, chat, messaging, organizing digital photos, watching movies, listening to songs, playing games and much more.

It is common knowledge that most computer systems basically organize and store data in the form of files. With the advent in file management technology in computer systems, users were provided with the option of storing and organizing files in folders/directories. Like for example, all files pertaining to, say, ‘Accounts’ could be clubbed together within a folder named ‘Accounts’, all files pertaining to ‘Games’ could be clubbed within a folder named ‘Games’ and so on. Further, there could be sub folders/directories within a folder/directory like for example, a folder named ‘Games’ could contain a sub folder named ‘Video Games’ that has files pertaining only to video games. This kind of folder based file management can be observed in almost all the modern computer systems today.

However, it is also accepted that folder based file management has its fair share of shortcomings. Let us consider an example—the user has created a folder named ‘PHOTOS’ for keeping all his/her digital photographs. If the user wishes to keep photographs pertaining to his/her family and work/business at separate places, he/she would have to create two sub folders named, say, ‘FAMILY PHOTOS’ and ‘WORK PHOTOS’ respectively under the ‘PHOTOS’ folder. Now in case of his/her family photos, if the user wants to further specifically organize photos pertaining to different events, occasions, trips and such others separately, he/she would have to create sub folders named, say, ‘VACATION PHOTOS’, ‘FESTIVAL PHOTOS’, ‘WEDDING PHOTOS’ and so on under the ‘FAMILY PHOTOS’ sub folder. Thus it can be observed here that for every new criteria of organization, the user has to create a new sub folder. If in case the number of sub folders under a folder, were to exceed beyond a particular limit, it would be a tedious and cumbersome process for the user to search and retrieve files through the same. Also, he/she would find it difficult to remember this large hierarchy of folders.

Further, there may arise a scenario wherein, at a time, a user may want to work on files stored in different folders stored on different locations on his/her computer system. Every time the user has to open a file, he/she has to open the relevant folder for the same. Further, the user will also need to toggle between such folders if he/she needs to open more files from the same. In case, there are too many open files and folders, working by toggling between the same would be a time consuming activity for the user. It would therefore help if there were a system that allowed the user to create, modify, and/or organize files from a single interface.

Further, in a typical folder based file management system if a person wishes to search for files, he/she is restricted to searching only by certain criteria like keywords in the file name, date of creation, date of modification and so on.

Further, it has been observed that a person can have files in different folders, whose contents may differ but there may still be some correlation between them. Like for example, say, a person goes on a family vacation to the ‘Jungfrau’ peak in the Swiss Alps every year. Every year, he/she clicks a set of digital photographs of the place. The photographs may be of the same location, but the settings and/or situations for the same may vary each year. Now, in case the person were to organize these photographs using a folder based file management system, he/she will need to create a folder named ‘FAMILY PHOTOS’, under that a sub folder named ‘VACATION PHOTOS’, under that another sub folder named ‘SWITZERLAND’, under that another sub folder for the year of visit say ‘2005’, ‘2006’, ‘2007’ and so on. It should be noted here that currently there is no utility to correlate the photographs stored in the folder for the year ‘2005’ to those stored in the folders for the year ‘2006’, ‘2007’ and so on. It would therefore help if there were a system that allowed the user to correlate files for the purpose of cross reference It would not be out of place here to mention that in most encyclopedias, whether in a book format or in an electronic format, if one searches for some article on a particular topic/category, then the article is brought forth along with one or more bookmarks/links to other related articles in the encyclopedia. These articles may or may not belong to the same topic/category as that of the parent article. From this fact, it can be inferred that the concept of cross reference has been in use ever since the inception of encyclopedias.

Further, it is well accepted that apart from files, people also like to store and organize URLs (Uniform Resource Locators) of websites, networks, blogs/forums, intranets, WAP (Wireless Application Protocol) portals and the like for future reference. It is also observed that the systems currently available offer limited utilities to the user for organizing and classifying URLs. Like for example, say a person has stored URLs belonging to different categories, and further he/she has marked some of them as personal ‘favourites’. Usually, a person would organize such URLs by bookmarking the same through a web browser application. This becomes a cumbersome activity over a period of time in case there are many URLs belonging to different categories. Alternately, the user would organize URLs in a text document or spreadsheet, by placing them under appropriate headers. This also turns out to be a cumbersome activity, in case the number of URLs is considerably large. It would therefore help if there were a system that would allow the user to store and organize URLs by well defined classifications, quickly and efficiently.

Further, it is well accepted that people like to create new files using the content, layout and/or formatting of an existing file. Like for example, if a person wishes to write a business letter in a text file, he/she is likely to make a copy of an earlier text file containing a business letter, and begin working on this copy. The person will now save this copy as a new file. In short it can be concluded that the person has used the earlier text file as a ‘template’ to create another file. Also, it should be accepted that a person may want to set more than one files as ‘templates’ and further would like to organize these ‘templates’ in a proper manner. It would therefore help if there were a system that allowed the user to do the same.

Further, it is well accepted that people like to share files with others for business or personal interests. Mostly people share files through sharing folders, e-mail, chat, MMS (Multimedia Messaging Service), WAP (Wireless Application Protocol), Bluetooth, FTP (File Transfer Protocol) and such other modes of sharing. However, it should be noted that currently a person cannot access such modes of sharing from a single interface, that is he/she has to navigate to the relevant interfaces on his/her computer system for this purpose. This would be a time consuming process if he/she were to share multiple files at a time. The above arguments will also hold good in case the user were organizing files on a mobile device or on a communications site comprising of one or more websites, networks, blogs/forums, intranets, WAP (Wireless Application Protocol) portals, and the like.

Further, it would not be out of place here to make a mention about web feeds. A web feed is a data format used for providing users with frequently updated content on a website, portal, blog, and the like. It is well known that there are many programs and/or applications available that allow users to store and organize web feeds in formats such as RSS (Really Simple Syndication). It has been observed that these programs and/or applications offer limited utilities to organize the web feeds. It would therefore help if there were a system that would allow the user to store and organize web feeds by well defined classifications.

The prior arts described in the foregoing descriptions have an inherent limitation, in that they do not do away with the need for a user to create, modify, organize, and/or share files and/or URLs in folders. That is, for organizing files, the user still has to depend on folders either in a direct or an indirect manner.

### 3849/DELNP/2005 System and Method Utilizing Virtual Folders

A system and method utilizing virtual folders (FIG. 3). The virtual folders expose regular files and folders to users in different views based on their metadata instead of the actual physical underlying file system structure on the disk (FIG. 3). The virtual folders (308) contain collections of items. The system includes a folder processor that obtains queries from a user (302) and a relational database (304) for storing information about the items. The folder processor first obtains a query from a user (302) and passes the query to the relational database (304). The relational database provides results back to the folder processor (306), and based on the results from the relational database, the folder processor provides the results to the user as virtual folders (308). Users are able to work with the virtual folders through direct manipulation (e.g., clicking and dragging, copying, pasting etc.)

U.S. Pat. No. 5,544,360 Method for Accessing Computer Files and Data, Using Linked Categories Assigned to Each Data File Record on Entry of the Data File Record

A computer filing system for accessing files and data according to user-designated criteria. The system allows the user to define a virtually unlimited number of hybrid folders by describing, using terms of their own selection, the file contents of those files which are to belong to particular hybrid folders. Such hybrid folders can be implemented on top of, and used in addition to, the normal hierarchical structured directory, or they may replace such normal structures entirely. The inventive computer file control system could therefore be used as the basis of a new computer operating system. In the process of search and retrieval, the invention ensures in two ways that the user defines a filter which will always find at least one file. The user is not required to type the key words to search but instead chooses the words from pick lists, making mistyping impossible. As the user builds the search filter definition, categories which would find no data are automatically excluded as pick list possibilities.

### WO2007120774 Method, Apparatus and Computer-Readable Medium to Provide Customized Classification of Documents in a File Management System

A customizable file template for use in a document or file management system to control how document files are classified, imported, and/or retrieved from the system. The method, as well as a corresponding apparatus and computer-readable medium, enables an administrator to generate a custom classification tree unique to his or her business enterprise by providing a user interface from which to select folder types and subclassifying document types for selected folder types. Editable folder types and document types are provided in respective regions of a graphical user interface. Selected folder and document types are placed into a scratchpad area of the graphical user interface to build the customized file tree. The customized classification tree is stored for subsequent use by a classifier to classify and import files into the document management system, and/or by an end user to access and view stored files arranged according to the customized file tree.

### BRIEF SUMMARY OF THE INVENTION

The present invention provides a system that allows the user to organize files by well defined classifications without needing to create separate sub folders for the same. The system offers the user the utility to search files by a wide variety of criteria and allows the user to access one or more modes of sharing files from a single interface.

The object of the invention is to provide an interactive system that, inter alia, does away with the need for a user, to create, store, organize and/or share files and/or uniform resource locators in folders and sub folders, on a computer system, mobile device, or on a communications site comprising of one or more websites, networks, blogs, forums, intranets, wireless application protocol portals and the like.

Another object of the present invention is to allow the user to build, share, and organize a databank of records classified by well-defined classifications including but not limited to Language, Index Letter, Date, Info Source, Type/Category, Subject, and Sub Subjects, and further utilities to modify, organize, and share this databank with others in various ways.

Yet another object of the present invention is to allow the user to link files and/or URLs (Uniform Resource Locators) from one or more folders on his/her computer system, mobile device, or on a communications site comprising of one or more websites, networks, blogs, forums, intranets, wireless application protocol portals and the like, to the records in the databank, and further provide the user with the option to delete/modify such links or link different files in place of the same.

Yet another object of the present invention is to provide a module that allows the user, inter alia, to build/create or import URLs (Uniform Resource Locators), and/or documents/files in popular file formats including but not limited to that of a text document, a spreadsheet, a presentation, a bitmap image, a rich text document and other formats possible at present or at any time in the future, by the aforementioned classifications.

Yet another object of the present invention is to provide a ‘Copy Current Entry’ utility that allows the user to copy existing classification and previously entered data for new data input by the user, for ease of data entry, with a choice of defining the extent of the details to be copied.

Yet another object of the present invention is to allow the user to view the list of records thus built/created or imported, according to their classifications like Language, Index Letter, Date, Info Source, Type/Category, Subject, and Sub Subjects, as well as by file format, and the records linked to them, such viewing being possible in the form of a ‘tree-view’

Yet another object of the present invention is to allow the user to Bookmark as well as mark the records in the databank as “Public” or “Private”, as well as “Favourite”, individually and further there is a utility which allows the user to globally do the same.

Yet another object of the present invention is to allow the user to link one or records in the databank, to one or more records in the databank for the purpose of cross-reference.

Yet another object of the present invention is to allow the user to link files and/or URLs to the records in the databank by a ‘dragging and dropping’ utility, as well as by a ‘Send To’ utility available on right click of a mouse or any other similar device.

Yet another object of the present invention is to index automatically or manually all the files and/or URLs on the user's computer system or on a communications site which may encompass one or more Websites, Networks, Blogs/Forums, Intranets, WAP (Wireless Application Protocol) portals, and such present or future technologies that are available, or may be available at any time in the future, and further display these files in a grid to the user, for importing the same into his/her respective databank.

Yet another object of the present invention is to allow the user to find the records in the databank by none or one or more FIND conditions including but not limited to classifications like the Date, Record ID, Language, Source of Information, Index Letter, Type/Category, Subject, and Sub Subjects, as well as by keywords, wildcard characters, File Attachments, Associations, Attachment Remarks, Association Remarks, Import Remarks, or Bookmark Remarks including, but not limited to, whether or not the record is marked as “Private” or “Public” or either “Favourite”, as well as by the file format. The user can exercise the option of using these conditions to bring forth or avoid records by the specified conditions.

Yet another object of the present invention is to allow the user to find records from the databank, which have the same and/or similar classifications.

Yet another object of the present invention is to allow the user to encrypt and decrypt records in the databank for security purposes.

Yet another object of the present invention is to allow the user to create files in one or more file formats by using respective ‘templates’, such files being saved at a location as may be determined by the user, and further their paths, classifications, other information, and metadata being saved in one or more databases.

Yet another object of the present invention is to allow the user to create, organize, send, and receive Web Feeds in formats including but not limited to RSS (Really Simple Syndication), Atom, and the like, to and from a communications site which may encompass one or more Websites, Networks, Blogs/Forums, Intranets, WAP (Wireless Application Protocol) portals, and such present or future technologies that are available, or may be available at any time in the future.

Yet another object of the present invention is to allow the user to share the records in the databank with others in the form of a database file and other file formats available currently or in the future, via various ways such as e-mail, chat, MMS (IVlultimedia Messaging Service), WAP (Wireless Application Protocol), Bluetooth, FTP (File Transfer Protocol), and such present or future technologies that are available, or may be available at any time in the future.

Yet another object of the present invention is to allow the user to back up the databank of records, so that in case the databank gets corrupted and/or the data is lost, the user can choose to restore data back to the databank from the backup he/she has taken.

### BRIEF DESCRIPTION OF THE DRAWING

FIG. 1 illustrates the elements of the interactive system that does away with the need for a user to create, store, organize and/or share files and/or URLs in folders and/or sub folders, according to an embodiment herein.

### DETAILED DESCRIPTION OF THE PRESENT INVENTION

A detailed description of the preferred embodiments and best modes for practicing the present invention are described herein.

An interactive system that, inter alia, does away with the need for a user, to create, store, organize and/or share files and/or uniform resource locators in folders and sub folders, on a computer system, mobile device, or on a communications site comprising of one or more websites, networks, blogs, forums, intranets, wireless application protocol portals and the like.

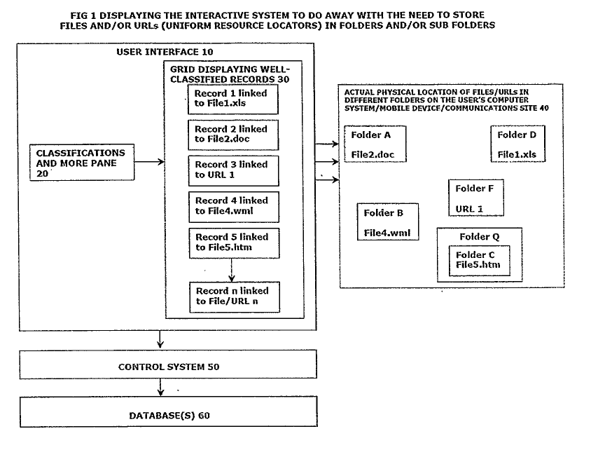

FIG. 1 illustrates few elements of the interactive system that does away with the need for a user to create, store, and/or organize files in folders, according to an embodiment herein. The said system consists of a User Interface 10 that renders the user's actions, and with the help of the Control system 50 transmits the appropriate requests to the Database(s) 60. The Control system 50 acts as the bridge between the User Interface 10 and the Database(s) 60.

The Database(s) 60s consists of a databank which is the reservoir of an extensible collection of well-classified data and further stores the data user wise, User Database and the Configuration Database. The User Database is the reservoir of the user information and also contains the history of past user interaction with the System. The Configuration Database is the reservoir of the options used for the customization of the system.

The User Interface 10 of the said system includes various elements including but not limited to the following:—

### 1. Grid Displaying Well-Classified Records 30

This is a grid 30 which displays the databank of records created or imported by the user from other users of the said system. These records are well-classified by classifications including but not limited to Language, Index Letter, Date, Info Source, Type/Category, Subject, and Sub Subjects.

The user can create a record in the databank by one or more methods including but not limited to the following:—
i) The user can create a record by entering the appropriate details in the relevant section of the user interface 10 of the said system.
ii) The user can create a new file through the user interface 10 of the said system which will be interpreted as a new record by the said system. This file could be of any type/format like for example a text document, a spreadsheet, a presentation and so on, provided that the relevant application to open/edit the file is present on the user's computer system, mobile device, or on a communications site comprising of one or more websites, networks, blogs/forums, intranets, WAP (Wireless Application Protocol) portals, and the like.
iii) The user can create a record by browsing for and selecting the appropriate file in a folder on his/her computer system, mobile device, or on a communications site comprising of one or more websites, networks, blogs/forums, intranets, WAP (Wireless Application Protocol) portals, and the like, and importing the same into the databank of the said system. The said system then generates a new record which is linked to the imported file. This file could be of any type/format like for example a text document, a spreadsheet, a presentation and so on.

From the above, it is inferred that the said system allows the user to create, modify, and/or import files, from a single interface. That is the user is spared the tedious effort of maintaining and organizing files in one or more folders and further sub folders. This is illustrated in FIG. 1, wherein the records displayed in the grid 30 are linked to files from different folders. Like for example, if there is a file named ‘File2.doc’ lying in a folder named A on any location on the user's computer system, mobile device, or on a communications site comprising of one or more websites, networks, blogs/forums, intranets, WAP (Wireless Application Protocol) portals, and the like, the user can import the same into the databank of the said system. Say, this file ‘File2.doc’ contains an article about the scientific phenomenon of gravity. Now, if the user were to organize this file using a folder based file management system, he/she would have to create a folder named ‘SCIENCE’, then a sub folder named ‘SCIENTIFIC PHENOMENA’, and further a sub folder named ‘GRAVITY’ which will store the file. On the contrary, if the user used the said system to organize the file, he/she will need to link the file to a record in the databank of the said system and then simply classify this record by giving appropriate classifications like language ‘ENGLISH’, source of information ‘PETER'S RESEARCH’, index letter ‘G’, Type/Category ‘SCIENTIFIC DOCUMENTS’, subject ‘SCIENCE’, sub subject 1 ‘SCIENTIFIC PHENOMENA’, sub subject 2 ‘GRAVITY’ and so on. Thus, it can be observed that in the earlier case the user had to create a hierarchy of folder and sub folders to organize a single file, while in the latter case the user can accomplish the same task much more efficiently without the need to create any folders and sub folders.

The said system will generate ‘Record no 1’, which will be linked to ‘File2.doc’. Further, the user can also import a file named ‘File5.htm’ lying in a folder named C which is a sub folder of a folder named Q. Thus, irrespective of where the files may be located on the user's computer system, mobile device, or on a communications site comprising of one or more websites, networks, blogs/forums, intranets, WAP (Wireless Application Protocol) portals, and the like, the said system still provides a way to link all such files to the records in the databank of the said system. The user can then perform various actions on these records in the same manner as that applicable in case of normal records in the databank of the said system.

The user can classify the Record through the said system by giving one or more appropriate classifications depending on the matter inside the file. Like for example, if the file ‘File2.doc’ is a text document containing an article about the Solar System then the appropriate classifications for the same could be Language ENGLISH, Index Letter S, Info Source PROFESSOR JAMES' NOTES, Type/Category HIGH SCHOOL, Subject SCIENCE, and Sub Subject ASTRONOMY. In case, the user were to classify ‘File2.doc’ using folders, he/she would have had to create separate folders for each classification, which would be a tedious and cumbersome process.

Further, in case the user has deleted ‘File2.doc’/modified the actual physical location of ‘File2.doc’ on his/her computer system, mobile device, or on a communications site comprising of one or more websites, networks, blogs/forums, intranets, WAP (Wireless Application Protocol) portals, and the like, the said system provides the user with the option to re-link ‘Record no 1’ in the databank to another file/‘File2.doc’ itself from its new physical location.

Further, another advantage of the above is that a user can find and retrieve a file much more easily as compared to browsing for the same in folders and sub folders. Like for example, if the user wishes to find the Record linked to ‘File2.doc’ as described above, he/she has to simply go to the relevant section of the user interface 10 of the said system, specify an appropriate find criteria like for example, say Sub Subject ASTRONOMY, and proceed.

The above arguments will also hold good in case the user wishes to import multiple files from one or more folders and/or sub folders at a time into the databank of the said system.

Further, the said system also allows the user to create files in one or more formats by invoking the relevant application for the same, if installed on the user's computer system. Thus the user can create files in different formats from a single interface rather than having the bother to invoke each application separately and then creating a file from the same. Like for example, under normal circumstances, if a user wishes to create a text document, he/she will need to first browse for and invoke the relevant application to edit text documents on his/her computer system and proceed further. The same applies in case of other files such as a spreadsheet, a presentation, and so on. In case the user wishes to work on several applications at a time, it would be a hassle for him/her to first browse and invoke the relevant application each time to create a new instance of a file, and then supply a location/folder to save this file. To overcome this, the said system allows the user to create a customized shortcut icon/menu item for one or more applications, on the user interface 10 of the said system. The user can invoke the relevant application by clicking or selecting the shortcut icon or menu item on the user interface 10 of the said system. The user can further choose to save the files created through these applications in a single folder/location designated through the said system. The files are visible upfront in the form of records in the grid 30 in the user interface 10 of the said system. This infers that the user does not have to bother about saving these files in a particular folder/location on his/her computer system.

Similarly, the user can also store and/or organize URLs (Uniform Resource Locators) as Records in the databank of the said system. The user can open up the URL in a communications site comprising of one or more websites, networks, blogs/forums, intranets, WAP (Wireless Application Protocol) portals, and the like, and select the same to be imported into the databank of the said system.

The user also has the option to import files and/or URLs into the databank of the said system by dragging and dropping, or by right clicking on the same with the help of a mouse or any other similar device

Further, the said system provides a ‘Copy Current Entry’ utility that allows the user to copy existing classification and previously entered data for new data input by the user, for ease of data entry, with a choice of defining the extent of the details to be copied. This utility is useful in that the user does not have to enter repetitive details each time he is building/creating and/or importing records, which fall under same or similar classifications.

Further, the said system also has an ability, on its startup, to automatically index all the files and/or URLs present on the user's computer system, mobile device, or on a communications site comprising of one or more websites, networks, blogs/forums, intranets, WAP (Wireless Application Protocol) portals, and the like, and display the same in the grid 30.

### 2. Classifications and More Pane 20

This is a pane of the user interface 10 that displays one or more parameters by which the user can filter the records displayed in the grid 30 mentioned above by various criteria including but not limited to Info Source, Type/Category, Subject, Sub Subjects, Index Letter, Attachment/Association, File Type, and records which have Cross References.

Further, the said system allows the user to perform various actions including but not limited to the following:—
i) Sharing records—The user can share the records in the databank with others in the form of a database 60 file and other file formats available currently or in the future, via various ways such as sharing folders, e-mail, chat, MMS (Multimedia Messaging Service), WAP (Wireless Application Protocol), Bluetooth, FTP (File Transfer Protocol), and the like.
ii) Cloning records—The user can clone, that is, create a copy of a record in the databank. The cloned record will have the same classifications and will be linked to the same file as that of the parent record.
iii) Marking records—The user can bookmark as well as mark the records in the databank as “Public” or “Private”, as well as “Favourite”, individually and further there is a utility which allows the user to globally do the same.
iv) Cross-referencing records—The user can link one or more records in the databank for the purpose of cross-reference. Like for example, if there is one record about the biography of famous physicist Albert Einstein, and another about one of his works the ‘photoelectric effect’, the user can ‘relate’ these records by the utility of cross referencing. A user can view the list of all cross-references for a particular record by navigating to the relevant section. He/she can further add, modify, as well as delete one or more cross-references.
v) Printing records—The user can print the records in the databank. In case of the records which are linked to files on the user's computer system, mobile device, or on a communications site comprising of one or more websites, networks, blogs/forums, intranets, WAP (Wireless Application Protocol) portals, and the like, the said system invokes the relevant application through which the files can be printed.
vi) Copying Classifications—The user can select a record in the databank and choose to copy its classifications including but not limited to Date, Record ID, Language, Source of Information, Index Letter, Type/Category, Subject, and Sub Subjects. The user can then use these classifications for classifying one or more similar records which he/she is creating/modifying in the databank.
vii) Finding records—The user can find the records in the databank by none or one or more FIND conditions including but not limited to classifications like the Date, Record ID, Language, Source of Information, Index Letter, Type/Category, Subject, and Sub Subjects, as well as by keywords, wildcard characters, File Attachments, Associations, Attachment Remarks, Association Remarks, Import Remarks, or Bookmark Remarks including, but not limited to, whether or not the record is marked as “Private” or “Public” or either “Favourite”, as well as by the file format. The user can exercise the option of using these conditions to bring forth or avoid records by the specified conditions.
   The user can also find records from the databank, which have the same and/or similar classifications.
viii) Encrypting/Decrypting records—The user can encrypt and decrypt records in the databank for security purposes. For encrypting records, the user can use various methods including but not limited to using an encryption password.
ix) Setting records as ‘templates’—The user can select a record and set it as a ‘template’ to create new records in the databank. Once a record has been set as a template, it is updated accordingly in the databank of the said system. The user can modify, rename as well as delete a record which has been set as a ‘template’ just as in case of a normal record in the databank.
   Like for example, say a record is linked to a file that contains a business proposal. Now, in case the user wishes to create another file containing another business proposal, he/she can set the earlier record as a ‘template’ and create a new file through the said system by using this ‘template’. The user can now create a business proposal using the common/similar elements present in the business proposal ‘template’.
   It should be noted that in normal folder based file management systems, to set a file as a template the user has to navigate to the location/folder where the file is stored and then make a copy of the same to be used as a ‘template’. This is a very tedious and time consuming task. On the contrary, the said system allows the user to set any record linked to a file, as a ‘template’ from a single interface and proceed. This is irrespective of the actual physical location of the file on the user's computer system, mobile device, or on a communications site comprising of one or more websites, networks, blogs/forums, Intranets, WAP (Wireless Application Protocol) portals.
   The user further has the option to choose whether or not to use such ‘templates’ as and when he/she requires the same.
x) Accessing right click options—The user can access one or more utilities of the said system through a right click menu available from the system tray of the user's computer system.)
xi) Backing up databank—The user can back up the databank of records, so that in case the databank gets corrupted and/or the data is lost, the user can choose to restore data back to the databank from the backup he/she has taken.
   For taking backup, the user will need to specify the location on his/her computer system, mobile device, or on a communications site comprising of one or more websites, networks, blogs/forums, intranets, WAP (Wireless Application Protocol) portals, and the like, for saving the backup file. The user can further choose to restore data from this backup file.
xii) Storing and organizing web feeds—The user can create, organize, send, and receive Web Feeds in formats including but not limited to RSS (Really Simple Syndication), Atom, and the like, to and from a communications site comprising of one or more websites, networks, Blogs/Forums, Intranets, WAP (Wireless Application Protocol) portals.
   For this, the user will first need to subscribe to a web feed from a web site, and enter the subscription URL (Uniform Resource Locator) of this web feed in the relevant module of the said system. The user will then start receiving the web feeds once the said system is connected to the Internet. After this, the user can organize these web feeds in the same manner as he/she would organize the records in the databank of the said system. The utilities that are applicable to the records would be applicable in case of the web feeds as well.

### TECHNICAL APPLICATION TO THE INDUSTRY

The invention has the potential to reduce people's dependency on the existing file management systems present in their computer systems, mobile devices, or on a communications site comprising of one or more websites, networks, blogs/forums, intranets, WAP (Wireless Application Protocol) portals. Following are some of the technical applications of the invention:—

### i) Web Content Management Systems

The invention can serve as a useful complementary tool to existing web content management systems in corporate organizations and enterprises. A web content management system primarily performs the task of keeping websites, blogs, portals and the like updated with the latest content.

ii) Knowledge and/or Information Management

The invention can serve as a useful complementary tool to aid in the knowledge and/or information management activities of corporate organizations and enterprises. Typically, such activities include creation, dissemination and use of knowledge/information within an organization.

1. An interactive system that, inter alia, does away with the need for a user, to create, store, organize and/or share files and/or uniform resource locators in folders and sub folders, on a computer system, mobile device, or on a communications site comprising of one or more websites, networks, blogs, forums, intranets, wireless application protocol portals and the like, the system comprising:—
i) a user interface;
ii) a well-classified database having;
a. a databank which is the reservoir of an extensible collection of well-classified data and further stores the data user wise;
b. a user database which is a reservoir of user information and also contains the history of past user interaction with the system;
c. a configuration database which is the reservoir of the options used for the customization of the system;
iii) a control system acting as a bridge between the user interface and the databases.
iv) a well classified data input organizing and management module enabling the user to classify the data by classifications selected or added in one or more of the groups consisting of date, language, source of information, index letter, type/category, subject, and sub subjects (bearing a parent-child relationship) and attach Image, animation and/or sound files and/or associate more Information to the data in the form of uniform resource locators, files, remarks and the like individually, and further there is a utility which allows the user to globally attach and/or associate files, uniform resource locators, remarks to the data.

2. The interactive system according to claim 1 further allows the user to link files of various formats, and/or uniform resource locators from one or more locations on the user's computer system, mobile device, or on a communications site comprising of one or more websites, networks, blogs/forums, intranets, wireless application protocol portals, to the records in the databank so that the user can view and/or modify such files and/or uniform resource locators from the interface of the said system, irrespective of their actual physical locations.

3. The interactive system according to claims 1 and 2 further allows the user to perform various actions on the records in the databank, including but not limited to modifying records, cloning records, cross-referencing records, bookmarking records as well as marking records as ‘public’ or ‘private’ as well as ‘favourite’, and encrypting/decrypting records for the purpose of security.

4. The interactive system according to claim 1 further allows the user to create, modify, and/or view the files and/or uniform resource locators, irrespective of the actual physical location of the same on the user's computer system, mobile device, or on a communications site which may encompass one or more websites, networks, blogs/forums, intranets, wireless application protocol portals.

5. The interactive system according to claim 1 further allows the user to set one or more records in the databank as ‘templates’ in order to create new records using the said ‘templates’, the same being saved at a location as may be determined by the user, and further their paths, classifications, other information, and metadata being saved in one or more databases.

6. The interactive system according to claim 1 further allows the user to classify the records linked to files and/or uniform resource locators by one or more classifications including but not limited to date, language, source of information, index letter, type/category, subject, and sub subjects.

7. The interactive system according to claim 1 further allows the user to copy existing classification and previously entered data for new data input by the user, for ease of data entry, with a choice of defining the extent of the details to be copied.

8. The interactive system according to claim 1 further allows the user to view one or more records in the databank filtered according to one or more parameters including but not limited to classifications like info source, type/category, subject and sub subjects, index letter, attachments/associations of files and/or uniform resource locators, file type, and/or records having cross references.

9. The interactive system according to claim 1 further allows the user to find the records in the databank by none or one or more find conditions including but not limited to classifications like the date, record id, language, source of information, index letter, type/category, subject, and sub subjects, as well as by keywords, wildcard characters, file attachments, associations, attachment and association remarks, import remarks, or bookmark remarks including, but not limited to, whether or not the record is marked as “private” or “public” or either “favourite”, as well as by the file format, and further exercise the option of using these conditions to bring forth or avoid records by the specified conditions.

10. The interactive system according to claims 1 and 9 further allows the user to find records from the databank, which have the same and/or similar classifications.

11. The interactive system according to claim 1 further allows the user to share the records in the databank with others in the form of a database file and other file formats available currently or in the future, via various ways such as sharing folders, e-mail, chat, multimedia messaging service, wireless application protocol, bluetooth, file transfer protocol, and the like.

12. The interactive system according to claim 1 further allows the user to back up the databank of records, so that in case the databank gets corrupted and/or the data is lost, the user can choose to restore data back to the databank from the backup he/she has taken.
